(19) United States
(12) Patent Application Publication
(10) Pub. No.: US 2013/0081430 A1
(43) Pub. Date: Apr. 4, 2013

(54) METHOD OF MANUFACTURING OPTICAL FIBER BASE MATERIAL AND METHOD OF MANUFACTURING OPTICAL FIBER

(71) Applicant: FUJIKURA LTD., Tokyo (JP)

(72) Inventors: Nobuo Oozeki, Sakura-shi (JP); Kentaro Ichii, Sakura-shi (JP); Tomofumi Arai, Sakura-shi (JP)

(73) Assignee: FUJIKURA LTD., Tokyo (JP)

(21) Appl. No.: 13/629,697

(22) Filed: Sep. 28, 2012

(30) Foreign Application Priority Data
Sep. 30, 2011 (JP) 2011-216439

(51) Int. Cl. C03B 37/018

(52) U.S. Cl. 65/419; 65/417

(57) ABSTRACT

Provided is a method of manufacturing an optical fiber base material using a MCVD method, including: a step of heating a glass tube while rotating the glass tube and supplying a gas into a through-hole of the glass tube, wherein in at least a part of the step, the inside of the through-hole is pressurized so that an outer diameter of the glass tube increases.

### BACKGROUND OF THE INVENTION

1. Field of the Invention

The present invention relates to a method of manufacturing an optical fiber base material that may manufacture a highly reliable optical fiber and a method of manufacturing an optical fiber using the same.

2. Description of Related Art

As one of methods of manufacturing an optical fiber base material, an MCVD (Modified Chemical Vapor Deposition) method is known. In the MCVD method, a glass tube of which both ends are fixed so as to be supported horizontally rotates about its axis and is heated by an external heat source. At this time, a raw material gas is supplied into a through-hole of the glass tube. Then, soot which is generated from the raw material gas is deposited and sintered, and a glass layer is laminated on the inner wall of the glass tube. Then, the entire glass tube collapses after a plurality of glass layers are laminated, and hence an optical fiber base material is manufactured.

However, since the glass tube is heated while both ends are fixed, the glass tube may be entirely bent in an arch shape or may be locally bent. The arch-like bending is different from the bending caused by the own weight of the glass tube, and maintains the glass tube to be bent in a specific direction. Accordingly, when such a bending occurs, whirling causing the eccentric rotation of the glass tube occurs with the rotation. The whirling also occurs even in a case where the glass tube is locally bent. Particularly, when the glass tube is long, the bending amount caused by the own weight increases, and hence there is a tendency that the bending more easily occurs.

When the whirling caused by such a bending of the glass tube occurs, a portion close to the heat source and a portion away from the heat source may be formed with the rotation of the glass tube. For this reason, the temperature distribution in the circumferential direction of the glass tube increases, and the deposition amount of soot (fine glass particles) may be unevenly distributed. For this reason, the eccentric amount of the core glass body in the manufactured optical fiber base material increases, and in the optical fiber which is manufactured by using the optical fiber base material, the eccentric amount exceeds an allowable amount, which may degrades the reliability.

As a method of suppressing the bending of the optical fiber base material, there is known a method of manufacturing an optical fiber base material disclosed in Japanese Patent Application National Publication No. 2005-520776. In the method of manufacturing the optical fiber base material, an auxiliary support member is used which supports the outer peripheral surface of the glass tube from the downside at the middle position of the glass tube of which both ends are fixed. Then, the glass tube is heated in a state that the glass tube is supported by the auxiliary support member while rotating. Since the bending of the glass tube while being heated is suppressed in this way, the above-described bending is suppressed and the eccentricity of the core glass body is reduced.

### SUMMARY OF THE INVENTION

However, in the method of manufacturing the optical fiber base material, since the auxiliary support member comes into contact with the outer peripheral surface of the glass tube, the outer peripheral surface of the glass tube may be scratched or impurities may be attached to the glass tube. In such a case, when the optical fiber is manufactured by using the manufactured optical fiber base material, there is a possibility that the core may become partially eccentric due to the influence of the scratches on the base material or the optical fiber may have a partially different refractive index due to the influence of the impurities attached onto the base material. Accordingly, there is a concern that an optical fiber having low reliability may be manufactured.

Therefore, it is an object of the invention to provide a method of manufacturing an optical fiber base material that may manufacture a highly reliable optical fiber and a method of manufacturing an optical fiber using the same.

In order to achieve the above mentioned object, the present invention is to provide a method of manufacturing an optical fiber base material using a MCVD method, which is characterized by containing a step of heating a glass tube while rotating the glass tube and supplying a gas into a through-hole of the glass tube, and in at least a part of the step, the inside of the through-hole is pressurized so that an outer diameter of the glass tube increases.

There is a tendency that the outer diameter of the heated glass tube is contracted due to the surface tension with a decrease in viscosity. Therefore, it is considered that the inside of the through-hole of the glass tube is pressurized so that the glass tube is not contracted due to the heat when a gas is supplied into the glass tube while the glass tube is heated. However, according to the study of the inventors, it was found that the bending of the glass tube occurred even in a case where the outer diameter of the glass tube was maintained to be constant by pressurizing the inside of the through-hole in this way. Therefore, the inventors carefully performed an examination, and obtained a conclusion that the bending of the glass tube could be suppressed when pressurizing the inside of the through-hole of the glass tube so that the outer diameter of the glass tube increases in at least a part of the step of heating the glass tube. There is no certain reason that the bending of the glass tube may be suppressed by pressurizing the inside of the through-hole of the glass tube in this way. However, the inventors consider that the shape of the glass tube may be maintained and the bending of the glass tube may be suppressed by the pressurization described above since the stress applied to the glass tube due to the pressure inside the through-hole is larger than the resistance due to the surface tension of the glass tube and the viscosity of the glass tube.

Accordingly, a change in distance with respect to the heat source heating the rotating glass tube is suppressed, and in the MCVD method, heat may be suppressed from being unevenly distributed in the circumferential direction of the glass tube when heating the glass tube. Accordingly, the soot derived from the raw material gas is deposited by a constant thickness in the circumferential direction, and the thickness of the glass layer in which the soot is laminated as glass is constant in the circumferential direction. In this way, the thickness of the glass tube is maintained to be constant. The eccentricity of the optical fiber base material manufactured by the step is suppressed, and since there is no member such as an auxiliary support member provided in the middle of the glass tube so as to come into contact with the glass tube, the mixture of impurities is also prevented. Accordingly, such an optical fiber base material may manufacture a highly reliable optical fiber.

Further, it is preferable that the step is a laminating step of laminating a glass layer on an inner wall of the glass tube, and the gas is a raw material gas for laminating the glass layer. In the laminating step of laminating the glass layer on the inner wall of the glass tube, the bending of the glass tube may be suppressed. Since the bending of the glass tube is suppressed in this way during the laminating step, the eccentricity of the optical fiber base material may be suppressed. Furthermore, the laminated glass layer may be the core glass body which becomes the core of the optical fiber, and may be the clad glass body which becomes the clad of the optical fiber.

Furthermore, in this case, it is preferable that a heat source heating the glass tube heats the glass tube while moving along the longitudinal direction of the glass tube, and the inside of the through-hole is pressurized so that the outer diameter of the glass tube increases by 0.040% to 0.160% while the heat source traverses once from a supply side of the raw material gas to a discharge side thereof.

Through the experiment of the inventors, it becomes apparent that the bending of the glass tube may be further suppressed by pressurizing the inside of the through-hole in this way. Accordingly, it is possible to manufacture the optical fiber base material that may manufacture the further highly reliable optical fiber by the pressurization in this way.

Further, it may be favorable that the inside of the through-hole is pressurized so that the outer diameter of the glass tube is constant from the middle of the laminating step. Since the bending of the glass tube does not easily occur with an increase in the thickness of the glass tube, it is possible to suppress the bending of the glass tube by pressurizing the glass tube so that the outer diameter of the glass tube increases until the middle of the laminating step. Then, the glass tube is pressurized so that the outer diameter of the glass tube becomes constant from the middle of the laminating step, and hence an unnecessary increase in the outer diameter of the glass tube may be prevented. Accordingly, the subsequent step may be easily performed.

Alternatively, it may be favorable that the inside of the through-hole is not pressurized from the middle of the laminating step. When the pressurization is stopped from the middle of the step of supplying the raw material gas while heating the glass tube, the glass is contracted. Accordingly, the increased outer diameter of the glass tube decreases by the step until the pressurization stops, and hence the subsequent step may be easily performed. Further, since the pressurization is not performed from the middle of the step, the amount of use of the gas for the pressurization may be decreased. Furthermore, even in a case where the pressurization stops in the middle of the laminating step, the bending of the glass tube may be suppressed by pressurizing the glass tube so that the outer diameter of the glass tube increases until the middle of the laminating step as described above.

Furthermore, it may be favorable that the inside of the through-hole is pressurized so that the outer diameter of the glass tube increases during the laminating step. By pressurizing the glass tube in this way, it is possible to further suppress the bending of the glass tube in the laminating step.

Alternatively, it may be favorable that the step is an etching step of etching an inner wall of the glass tube, and the gas is an etching gas. In a case of performing the MCVD method, in general, the etching step of etching the inner wall of the glass tube is performed before the raw material gas is supplied to the glass tube or after the glass layer obtained by the raw material gas is laminated. Furthermore, the glass tube on which the glass layer is laminated indicates the glass tube on which the glass layer is not laminated yet and the glass tube formed of the laminated glass layer. In this case, the inner wall corresponds to the inner wall of the laminated glass layer. Even in a case where the inner wall of the glass tube is etched in this way, the glass tube is heated, which may cause the bending of the glass tube. However, since the glass tube is pressurized so that the outer diameter of the glass tube increases as described above, it is possible to suppress the bending of the glass tube in the etching step. Accordingly, when the etching step in which the glass tube may be bent as described above is the etching step before the raw material gas is supplied to the glass tube, it is possible to prevent the soot from being unevenly distributed in the circumferential direction of the glass tube in a case where the glass layer is laminated on the inner wall of the glass tube later. Further, even when the step in which the glass tube may be bent as described above is the etching step after the glass layer is laminated on the glass tube, the bending of the optical fiber base material may be suppressed. In this way, the optical fiber base material which may manufacture the highly reliable optical fiber may be manufactured by the pressurization as described above in the etching step.

Further, it is preferable that the pressurization is performed by supplying a pressurization gas to the gas discharge side of the glass tube. Since the pressurized gas is supplied to the gas discharge side, it is possible to suppress the influence of the gas supply amount. For example, in a case where the gas is the raw material gas as described above, a decrease in the supply amount of the raw material gas is suppressed by supplying the pressurized gas from the discharge side, and hence the glass layer may be laminated according to the design. Further, in a case where the raw material gas is the etching gas as described above, it is possible to suppress a decrease in the supply amount of the etching gas, and hence it is possible to etch the inner wall of the glass layer according to the design.

In addition, a method of manufacturing an optical fiber of the present invention includes an optical fiber base material manufacturing step of manufacturing an optical fiber base material using an MCVD method, and a drawing step of drawing the optical fiber base material, and is characterized in that in the manufacturing of the optical fiber base material, a glass tube is heated while rotating and a gas is supplied into a through-hole of the glass tube, where in at least a part of the heating and the supplying, the inside of the through-hole is pressurized so that the outer diameter of the glass tube increases.

In at least a part of the step of heating the glass tube, the bending of the glass tube may be suppressed by pressurizing the inside of the through-hole of the glass tube so that the outer diameter of the glass tube increases. Accordingly, in the MCVD method, it is possible to suppress the thickness of the laminated glass layer from becoming different in the circumferential direction. For this reason, the eccentricity of the manufactured optical fiber base material is suppressed, and a highly reliable optical fiber may be manufactured by drawing the optical fiber base material.

As described above, according to the invention, a method of manufacturing an optical fiber base material that may manufacture a highly reliable optical fiber and a method of manufacturing an optical fiber using the same are provided.

### BRIEF DESCRIPTION OF THE DRAWINGS

FIG. 1 is a diagram illustrating a structure of a cross section perpendicular to a longitudinal direction of an optical fiber according to a first embodiment of the invention;

FIG. 2 is a diagram illustrating an optical fiber base material which is used to manufacture the optical fiber illustrated in FIG. 1;

FIG. 3 is a flowchart illustrating a step of manufacturing the optical fiber base material and a step of manufacturing the optical fiber;

FIG. 4 is a diagram illustrating a base material manufacturing device on which a glass tube is set;

FIG. 5 is a diagram illustrating an appearance of a laminating step;

FIG. 6 is a diagram illustrating an appearance of a drawing step;

FIG. 7 is a diagram illustrating a structure of a cross section perpendicular to a longitudinal direction of an optical fiber according to a second embodiment of the invention; and

FIG. 8 is a diagram illustrating a relation between an average expansion amount per each traverse and a whirling amount of a glass tube.

### DETAILED DESCRIPTION OF EMBODIMENTS

Hereinafter, preferred embodiments of a method of manufacturing an optical fiber base material and a method of manufacturing an optical fiber according to the invention will be described by referring to the drawings.

### First Embodiment

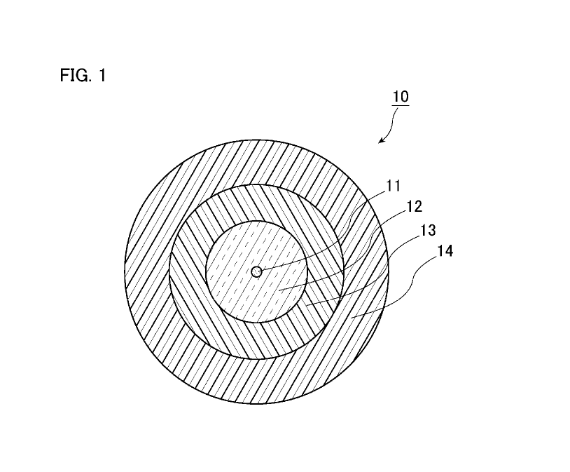

FIG. 1 is a diagram illustrating a structure of a cross section perpendicular to a longitudinal direction of an optical fiber according to a first embodiment of the invention. An optical fiber 10 of the embodiment is, for example, a single-mode fiber, and as illustrated in FIG. 1, includes a core 11, a clad 12 which surrounds the outer peripheral surface of the core 11, a first coating layer 13 which coats the outer peripheral surface of the clad 12, and a second coating layer 14 which coats the outer peripheral surface of the first coating layer 13. The refractive index of the clad 12 is lower than the refractive index of the core 11. As a material of forming such a core 11, for example, quartz to which an element of germanium increasing a refractive index is added may be exemplified. Further, as a material of forming the clad 12, for example, pure quartz to which no dopant is added may be exemplified. Further, as a material of forming the first coating layer 13 and the second coating layer 14, for example, different types of UV-ray curable resins may be exemplified.

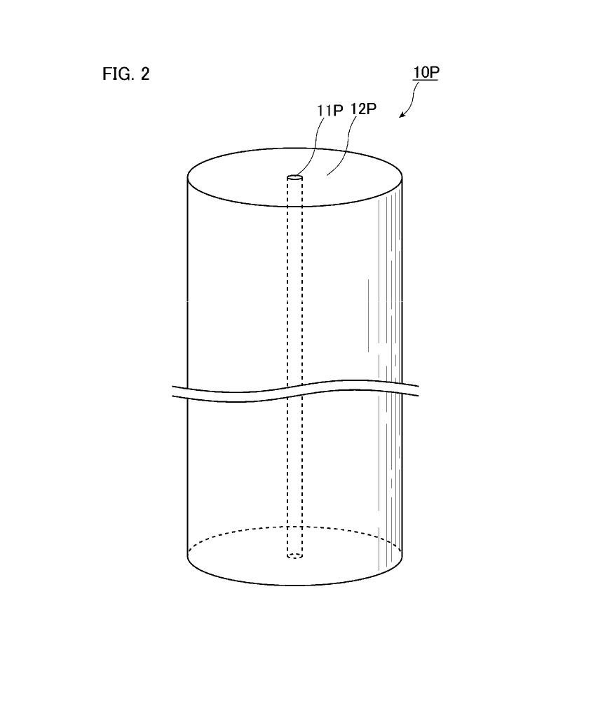

Such an optical fiber 10 is manufactured by drawing an optical fiber base material as described below. FIG. 2 is a diagram illustrating the optical fiber base material which is used to manufacture the optical fiber 10 illustrated in FIG. 1. As illustrated in FIG. 2, an optical fiber base material 10P has a column shape, and includes a core glass body 11P which becomes the core 11 of the optical fiber 10 and a clad glass body 12P which surrounds the outer peripheral surface of the core glass body 11P and becomes the clad 12 of the optical fiber 10.

The core glass body 11P is formed of the same material as that of the core 11 of the optical fiber 10, and the clad glass body 12P is formed of the same material as that of the clad 12. Then, the ratio between the diameter of the core glass body 11P and the outer diameter of the clad glass body is substantially identical to the ratio between the diameter of the core 11 of the optical fiber 10 and the outer diameter of the clad 12.

Next, a method of manufacturing the optical fiber base material 10P and manufacturing the optical fiber 10 using the manufactured optical fiber base material 10P will be described.

FIG. 3 is a flowchart illustrating a step of manufacturing the optical fiber base material 10P and a step of manufacturing the optical fiber 10. As illustrated in FIG. 3, the method of manufacturing the optical fiber base material 10P mainly includes a preparing step P1 in which a glass tube is set on a base material manufacturing device, an etching step P2 in which the inner wall of the glass tube is etched, a laminating step P3 in which a glass layer is laminated on the inner wall of the glass tube, and a collapse step P4 in which an optical fiber base material is obtained by crushing a through-hole of the glass tube. The method of manufacturing the optical fiber 10 mainly includes the respective steps and a drawing step P5 in which the optical fiber base material 10P is drawn.

<Preparing Step P1>

First, a glass tube is prepared. Since the glass tube becomes a part of the clad glass body 12P of the optical fiber base material 10P, the glass tube is formed of the same material as that of the clad 12 of the manufactured optical fiber 10. The surface of the prepared glass tube is cleaned if necessary.

Next, the glass tube is set on a base material manufacturing device.

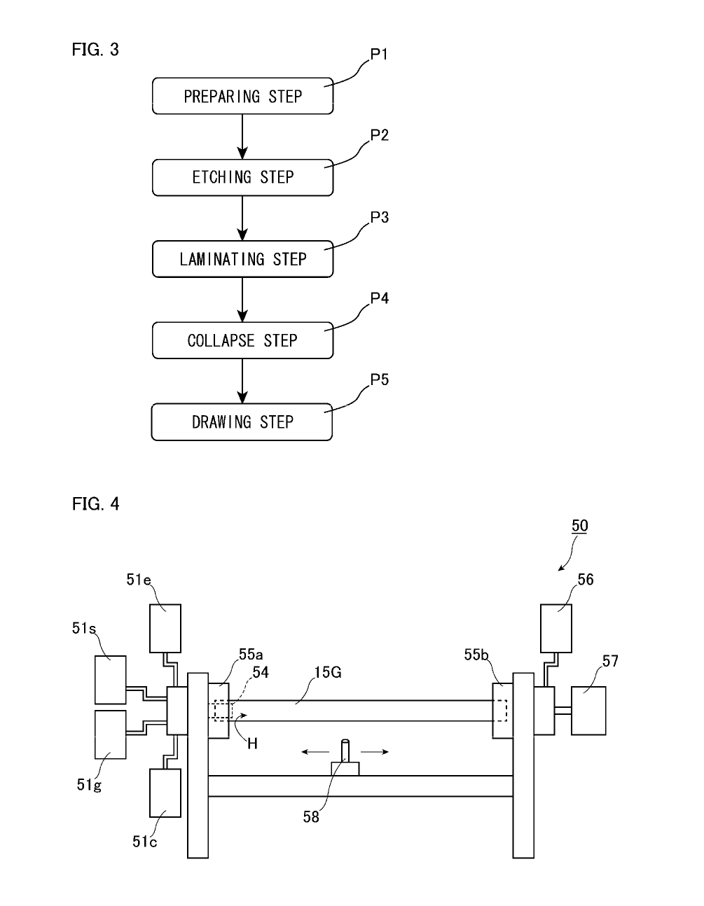

FIG. 4 is a diagram illustrating the base material manufacturing device on which a glass tube 15G is set. As illustrated in FIG. 4, a base material manufacturing device 50 mainly includes a pair of chucking portions 55a and 55b which is capable of fixing both end portions of the glass tube 15G, an SiCl₄ gas supply portion 51s which supplies an SiCl₄ gas, a GeCl₄ gas supply portion 51g which supplies a GeCl₄ gas, a carrier gas supply portion 51c which supplies a carrier gas, an etching gas supply portion 51e which supplies an etching gas, a gas supply pipe 54 which supplies an SiCl₄ gas, a GeCl₄ gas, a carrier gas, an etching gas, and the like to the glass tube 15G, an exhaust gas treatment portion 57 which treats an unnecessary gas discharged from the glass tube, a pressurized gas supply portion 56 which supplies a pressurization gas to the gas discharge side of the glass tube 15G, and a burner 58 which is movable in the longitudinal direction of the glass tube 15G and heats the outer peripheral surface of the glass tube 15G.

The chucking portions 55a and 55b may horizontally support the glass tube 15G, where the chucking portion 55a fixes one end portion of the glass tube 15G and the chucking portion 55b fixes the other end portion of the glass tube 15G. Further, the respective chucking portions 55a and 55b are configured to be rotatable about the axis of the glass tube 15G.

Further, the gas supply pipe 54 is configured such that its front end is slightly inserted into a through-hole H of the glass tube 15G in a state where the glass tube 15G is fixed to the chucking portion 55a.

The SiCl₄ gas supply portion 51s is configured to supply SiCl₄ as steam, for example, SiCl₄ bubbling. Further, the GeCl₄ gas supply portion 51g is configured to supply GeCl₄ as steam, for example, GeCl₄ bubbling. Further, the carrier gas supply portion 51c generates a carrier gas which carries a SiCl₄ gas or a GeCl₄ gas. The carrier gas is formed of, for example, an inert gas such as a nitrogen gas. In a case where the carrier gas is a nitrogen gas, a nitrogen gas having a small amount of impurities may be supplied when a device generating an N₂ gas from liquid nitrogen is used. Further, the etching gas supply portion 51e is configured to supply an etching gas capable of etching the glass tube 15G, and as such an etching gas, an SF₆ gas may be exemplified.

Furthermore, respective pipes are connected to the SiCl₄ gas supply portion 51s, the GeCl₄ gas supply portion 51g, the carrier gas supply portion 51c, and the etching gas supply portion 51e, and these pipes are connected to the gas supply pipe 54. Accordingly, the respective gases are supplied into the through-hole H of the glass tube 15G through the gas supply pipe 54. Further, a valve (not illustrated) is provided in the course of each pipe, and hence the supply of each gas may be controlled.

The exhaust gas treatment portion 57 is configured to accumulate an unnecessary gas discharged from the through-hole H of the glass tube 15G.

The pressurized gas supply portion 56 is disposed at the gas discharge side of the glass tube 15G, and is configured to supply a pressurized gas from a direction substantially perpendicular to the longitudinal direction of the glass tube 15G. As the pressurized gas, an inert gas such as a nitrogen gas may be exemplified.

The burner 58 is, for example, an oxyhydrogen burner, and as described above, is configured to be movable in the longitudinal direction of the glass tube 15G as described above.

When both end portions of the glass tube 15G are fixed to the pair of chucking portions 55a and 55b of the base material manufacturing device 50, the glass tube 15G is set on the base material manufacturing device 50 as described above. In this way, the preparing step P1 is completed.

<Etching Step P2>

Next, the inner wall of the glass tube 15G which is set on the base material manufacturing device 50 is etched. Specifically, the glass tube 15G is rotated about the axis by rotating the chucking portions 55a and 55b, and the glass tube 15G is heated by reciprocating the burner 58 along the longitudinal direction of the glass tube 15G.

Then, an etching gas is supplied from the etching gas supply portion 51e and a carrier gas is supplied from the carrier gas supply portion 51c during a time in which the glass tube 15G is heated, and these gases are supplied into the through-hole H of the glass tube 15G through the gas supply pipe 54. The temperature of the glass tube 15G at this time is not particularly limited as long as the glass tube may be etched, and is, for example, 1900° C. to 2300° C. Furthermore, a pressurized gas is supplied from the pressurized gas supply portion 56 at this time so as to pressurize the through-hole H of the glass tube 15G. The pressurization at this time is performed so that the outer diameter of the glass tube 15G increases. Specifically, the inside of the through-hole H is pressurized so that the outer diameter of the glass tube 15G increases by, for example, 0.040% to 0.160% during a time when the burner 58 traverses the glass tube 15G once. Furthermore, as described above, since the etching gas is supplied from the etching gas discharge side of the glass tube, the dilution of the etching gas by the pressurized gas is suppressed, and the etching may be performed according to the designed value.

In this way, the inner wall of the glass tube 15G is etched by the etching gas.

<Laminating Step P3>

Next, the glass layer is laminated on the inner wall of the glass tube 15G subjected to the etching step. In the embodiment, a clad glass layer which becomes the clad glass body 12P is first laminated on the inner wall of the glass tube 15G, and then a core glass layer which becomes the core glass body 11P is laminated thereon.

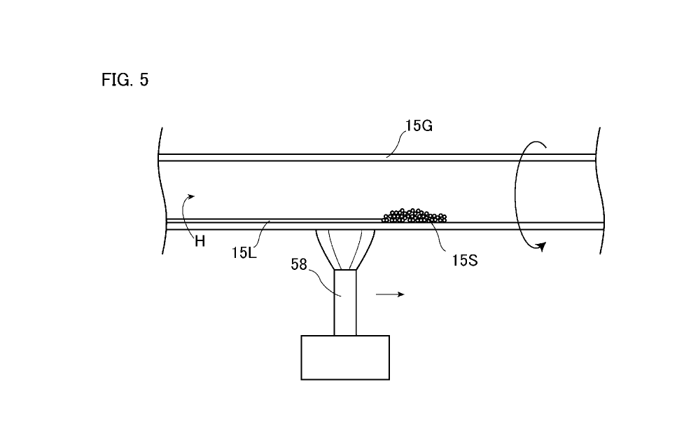

FIG. 5 is a diagram illustrating an appearance of the laminating step P3. As illustrated in FIG. 5, in the laminating step, as in the etching step P2, the glass tube 15G is rotated about the axis by rotating the chucking portions 55a and 55b, and the glass tube 15G is heated by moving the burner 58 along the longitudinal direction of the glass tube 15G. In the MCVD method, in a so-called forward traverse in which the burner 58 moves from the supply side of a raw material gas such as SiCl₄ or GeCl₄ to the discharge side thereof, soot 15S derived from the raw material gas is deposited at the discharge side in relation to the burner 58, the deposited soot 15S is heated by the movement of the burner 58, and a glass layer 15L is laminated. Then, the laminated glass layer 15L becomes a part of the glass tube 15G, and the thickness of the glass tube 15G is thickened whenever the glass layer 15L is laminated. Furthermore, in the forward traverse, the burner 58 is moved at a comparatively low speed. Further, in a so-called backward traverse in which the burner moves from the discharge side of the raw material gas to the supply side thereof, the burner is moved quickly so that the burner is returned to the supply side of the raw material gas since the backward traverse is not concerned with the formation of the glass layer.

Since the rotation speed of the glass tube 15G and the movement speed of the burner 58 in the forward traverse are different depending on the thickness or the diameter of the glass tube 15G, the rotation speed and the movement speed are not particularly limited. However, for example, the rotation speed of the glass tube 15G is 5 rpm to 75 rpm and the movement speed of the burner 58 is 30 mm/min to 200 mm/min. Further, the temperature of the glass tube 15G in the forward traverse is not particularly limited as long as the glass layer 15L is adopted in which soot 15S of the raw material gas is deposited and the deposited soot becomes glass. However, the temperature is, for example, 1900° C. to 2300° C.

In the lamination of the clad glass layer, a carrier gas and an SiCl₄ gas (a raw material gas) are supplied from the carrier gas supply portion 51c and the SiCl₄ gas supply portion 51s of the base material manufacturing device 50 into the glass tube 15G through the gas supply pipe 54.

Further, when the clad glass layer is laminated by a predetermined number, the core glass layer is laminated. In the lamination of the core glass layer, a raw material gas which is formed of a carrier gas, an SiCl₄ gas, and a GeCl₄ gas is supplied into the glass tube 15G from the carrier gas supply portion 51c, the SiCl₄ gas supply portion 51s, and the GeCl₄ gas supply portion 51g of the base material manufacturing device 50 through the gas supply pipe 54.

Then, in at least a part of time when laminating the clad glass layer and the core glass layer, the inside of the through-hole H of the glass tube 15G is pressurized by supplying a pressurized gas from the pressurized gas supply portion 56. The pressurization at this time is performed so that the outer diameter of the glass tube 15G increases. Specifically, it is preferable that the inside of the through-hole H is pressurized so that the outer diameter of the glass tube 15G increases by, for example, 0.040% to 0.160% during a time when the burner 58 traverses the glass tube 15G from the supply side of the raw material gas to the discharge side thereof once. In this way, it is apparent that the bending of the glass tube 15G may be further suppressed by pressurizing the inside of the through-hole H through the experiment of the inventors. Accordingly, it is possible to manufacture the optical fiber base material 10P which may manufacture the further highly reliable optical fiber 10 by the pressurization in this way.

Furthermore, as described above, since the pressurized gas is supplied from the discharge side of the raw material gas in the glass tube, the dilution of the raw material gas by the pressurized gas is suppressed, and the lamination may be performed according to the designed value.

Furthermore, the pressurization is performed to the middle of the laminating step P3 in which the glass layer is laminated, and the inside of the through-hole H of the glass tube 15G may be pressurized so that the outer diameter of the glass tube 15G becomes constant from the middle of the laminating step P3. For example, the pressurization is performed so that the outer shape of the glass tube 15G increases in the entire time of forming the clad glass layer and the middle of the time of forming the core glass layer and the pressurization is performed so that the outer shape of the glass tube 15G becomes constant from the middle of the time of forming the core glass, or the pressurization is performed so that the outer shape of the glass tube 15G increases at the time of forming the clad glass layer, the pressurization is performed so that the outer shape of the glass tube 15G becomes constant at the time of forming the core glass. Since the bending of the glass tube 15G hardly occurs with an increase in the thickness of the glass tube 15G, the bending of the glass tube 15G may be suppressed by pressurizing the glass tube so that the outer diameter of the glass tube 15G increases to the middle of the laminating step P3. Then, an unnecessary increase in the outer diameter of the glass tube 15G is prevented by pressurizing the glass tube so that the outer diameter of the glass tube 15G becomes constant from the middle of the laminating step P3, and hence the subsequent steps may be easily performed.

Alternately, the inside of the through-hole H may not be pressurized from the middle of the laminating step P3. For example, the pressurization is performed so that the outer shape of the glass tube 15G increases in the entire time of forming the clad glass layer and the middle of the time of forming the core glass layer, and the pressurization is not performed from the middle of the time of forming the core glass. The glass is contracted by stopping the pressurization from the middle of the step in which the raw material gas is supplied while heating the glass tube 15G. Accordingly, the increased outer diameter of the glass tube 15G is decreased by the step until the pressurization stops, and hence the subsequent step may be easily performed. Further, the amount of use of the pressurized gas may be reduced by stopping the pressurization from the middle of the time. Furthermore, even when the pressurization is stopped in the middle of the laminating step P3, the bending of the glass tube 15G may be suppressed since the pressurization is performed so that the outer diameter of the glass tube 15G increases until the middle of the laminating step P3 as described above.

Further, alternatively, the inside of the through-hole H may be pressurized so that the outer diameter of the glass tube 15G constantly increases during the laminating step P3. By pressurizing the glass tube in this way, the bending of the glass tube 15G may be further suppressed in the laminating step P3.

In this way, the clad glass layer and the core glass layer are laminated by a predetermined number.

<Collapse Step P4>

In the step, the supply of the raw material gas is stopped after the clad glass layer and the core glass layer are laminated, and the burner 58 is reciprocated so as to heat the glass tube 15G. By the heating, the through-hole H of the glass tube 15G is contracted and the through-hole H is crushed.

Furthermore, in the step, an etching step in which the inner wall of the glass tube 15G is etched may be performed before the through-hole H of the glass tube 15G decreases in diameter or while the through-hole H decreases in diameter. The etching step in this case may be performed as in the above-described etching step P2. That is, the glass tube 15G is etched in a state where an axis 15C is warped upward so as to have a catenary curve of a vertically reverse shape. In this way, even when the etching step is performed before or during the collapse step P4, the bending of the optical fiber base material may be suppressed. Furthermore, as in the step, the glass tube 15G on which the glass layer 15L is laminated indicates the glass tube 15G on which the glass layer 15L is not laminated yet and the glass tube which is formed of the laminated glass layer 15L, and the inner wall in this case becomes the inner wall of the laminated glass layer 15L. In this way, the optical fiber base material 10P illustrated in FIG. 2 is obtained.

<Drawing Step P5>

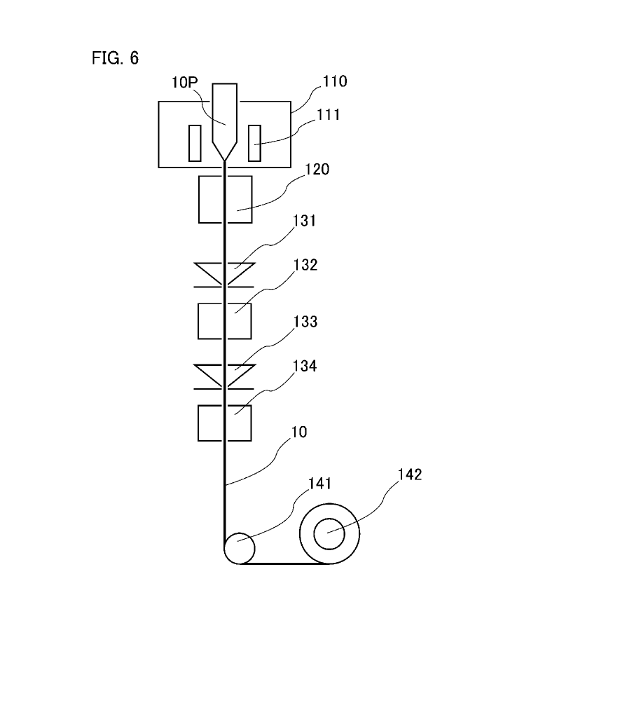

FIG. 6 is a diagram illustrating an appearance of the drawing step P5.

First, the optical fiber base material 10P which is manufactured by the preparing step P1 to the collapse step P4 as preparation steps for performing the drawing step P5 is set on a spinning furnace 110. Then, the optical fiber base material 10P is heated by generating heat from a heating portion 111 of the spinning furnace 110. The lower end of the optical fiber base material 10P at this time is heated to, for example, 2000° C. and becomes a melted state. Then, glass is melted from the optical fiber base material 10P, and glass is drawn. When the drawn melted glass exits the spinning furnace 110, the melted glass is immediately solidified. Accordingly, the core glass body 11P becomes the core 11, and the clad glass body 12P becomes the clad 12, thereby obtaining the optical fiber having the core 11 and the clad 12. Subsequently, the optical fiber passes through a cooling device 120, and is cooled to an appropriate temperature. The temperature of the optical fiber when entering the cooling device 120 is, for example, about 1800° C., but the temperature of the optical fiber when exiting the cooling device 120 is, for example, 40° C. to 50° C.

Next, the optical fiber passes through a coating device 131 provided with a UV-ray curable resin becoming the first coating layer 13 and is coated with the UV-ray curable resin. Further, the optical fiber passes through the UV-ray irradiating device 132 so as to be irradiated with an UV ray, so that the UV-ray curable resin is cured and the first coating layer 13 is formed. Next, the optical fiber passes through a coating device 133 provided with a UV-ray curable resin becoming the second coating layer 14, and is coated with the UV-ray curable resin. Further, the optical fiber passes through a UV-ray irradiating device 134 so as to be irradiated with a UV ray, so that the UV-ray curable resin is cured and the second coating layer 14 is formed, thereby obtaining the optical fiber 10 illustrated in FIG. 1.

Then, the direction of the optical fiber 10 is changed by a turn pulley 141 and the optical fiber is wound by the reel 142.

As described above, according to the method of manufacturing the optical fiber base material 10P of the embodiment, the bending of the glass tube 15G may be suppressed by pressurizing the inside of the through-hole H of the glass tube 15G so that the outer diameter of the glass tube 15G increases in a part of the etching step P2 or the laminating step P3 in which the glass tube is heated. There is no certain reason that the bending of the glass tube 15G may be suppressed by pressurizing the glass tube 15G in this way. However, the inventors consider that the stress applied to the glass tube 15G due to the pressure inside the through-hole H matches the resistance due to the surface tension of the glass tube 15G and the viscosity of the glass tube 15G by the pressurization described above.

Accordingly, a change in distance between the rotating glass tube 15G and the burner 58 heating the glass tube 15G is suppressed, and the eccentric distribution of the heat in the circumferential direction of the glass tube 15G is suppressed when heating the glass tube 15G in the MCVD method. Accordingly, the soot 15S which is derived from the raw material gas is laminated with the substantially constant thickness in the circumferential direction, and the thickness of the glass layer 15L in which the soot 15S is laminated as a glass is substantially constant in the circumferential direction. In this way, the thickness of the glass tube 15G is maintained at the substantially constant thickness. Since the optical fiber base material 10P is manufactured by these steps, the eccentricity of the optical fiber base material 10P may be suppressed. Then, the highly reliable optical fiber 10 may be manufactured by drawing the optical fiber base material 10P.

### Second Embodiment

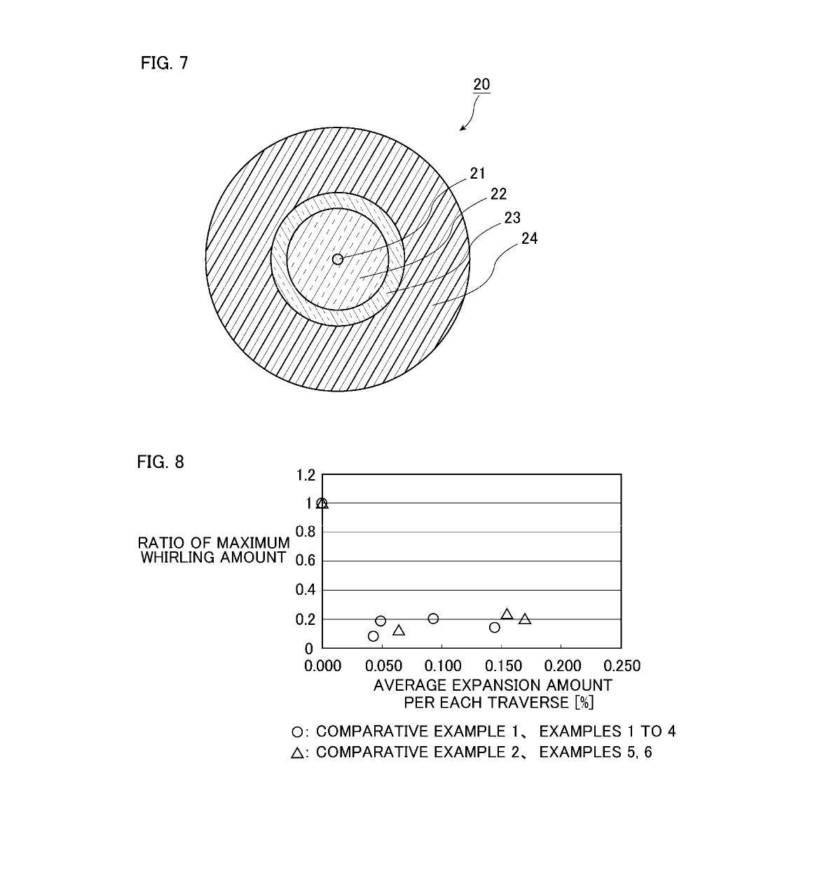

Next, a second embodiment of the invention will be described in detail by referring to FIG. 7. Furthermore, the identical reference numerals will be given to the identical or similar components to those of the first embodiment unless there is a particular description, and the description thereof will not be repeated. FIG. 7 is a diagram illustrating a structure of a cross section perpendicular to a longitudinal direction of an optical fiber according to the second embodiment of the invention.

As illustrated in FIG. 7, an optical fiber 20 of the embodiment is an amplification optical fiber (a double clad fiber) in which a active element is added to a core, and includes a core 21, a clad 22 which surrounds the core 21, a resin clad 23 which coats the clad 22, and a coating layer 24 which coats the resin clad 23. The refractive index of the clad 22 is lower than the refractive index of the core 21, and the refractive index of the resin clad 23 is further lower than the refractive index of the clad 22. As a material of forming such a core 21, glass in which a active element such as Yb pumped by pumping light is added to the same material as that of the core 11 of the optical fiber 10 of the first embodiment may be exemplified. As such a active element, a rare-earth element may be exemplified, and as the rare-earth element, thulium (Tm), cerium (Ce), neodymium (Nd), europium (Eu), erbium (Er), and the like may be exemplified other than Yb. Furthermore, as the active element, bismuth (Bi) and the like may be exemplified other than the rare-earth element. Further, as a material of forming the clad 22, for example, the same material as that of the clad 12 of the optical fiber 10 of the first embodiment may be exemplified. Further, as a material of forming the resin clad 23, for example, a light transmissive UV-ray curable resin may be exemplified, and as a material of forming the coating layer 24, the same material as that of the second coating layer 14 of the optical fiber 10 of the first embodiment may be exemplified.

The optical fiber base material used to manufacture the optical fiber 20 has the same appearance as that of the optical fiber base material 10P illustrated in FIG. 2, and is different from the optical fiber base material 10P in that the active element is added to the core glass body 11P.

The method of manufacturing the optical fiber 20 is as below.

(First Manufacturing Method)

In a first manufacturing method, the preparing step P1 and the etching step P2 are performed as in the method of manufacturing the optical fiber base material 10P of the first embodiment. Furthermore, even in the manufacturing method of the embodiment, the inside of the through-hole H of the glass tube 15G is pressurized in the etching step P2 so that the outer diameter of the glass tube 15G increases as in the etching step P2 of the first embodiment.

Then, the step of laminating the clad glass layer of the laminating step P3 is performed as in the step of laminating the clad glass layer of the first embodiment, and in the step of laminating the core glass layer, a gas in which a active element changed to a gas phase is supplied into the through-hole H of the glass tube 15G other than a carrier gas, a SiCl₄ gas, and a GeCl₄ gas. Accordingly, the base material manufacturing device of the embodiment includes a heating device that changes a active element into a gas phase in addition to the configuration of the base material manufacturing device 50 of the first embodiment, and the active element which is changed as the gas phase by the heating device is supplied into the through-hole H of the glass tube 15G through the gas supply pipe 54. Furthermore, even in the manufacturing method of the embodiment, the inside of the through-hole H of the glass tube 15G is pressurized in the laminating step P3 so that the outer diameter of the glass tube 15G increases as in the laminating step P3 of the first embodiment.

Then, the collapse step P4 is performed as in the first embodiment after a predetermined number of the core glass layers are laminated, and the optical fiber base material for manufacturing the optical fiber 20 of FIG. 7 is obtained. Furthermore, even in the embodiment, the etching step may be performed before or during the collapse step P4 as in the first embodiment.

Next, the drawing step P5 is performed. The drawing step P5 is different from the drawing step P5 of the first embodiment in that the UV-ray curable resin becoming the resin clad 23 is used instead of the UV-ray curable resin becoming the first coating layer 13 in the coating device 131, and the other points are the same as those of the drawing step P5 of the first embodiment.

In this way, the optical fiber 20 illustrated in FIG. 7 is obtained.

(Second Manufacturing Method)

In a second manufacturing method, the preparing step P1 and the etching step P2 are performed as in the first manufacturing method, and further the clad glass layer of the laminating step P3 is formed as in the first manufacturing method. Furthermore, even in the manufacturing method, the inside of the through-hole H of the glass tube 15G is pressurized so that the outer diameter of the glass tube 15G increases as in the first manufacturing method in the etching step P2 and the step of laminating the clad glass layer of the laminating step P3.

Then, the lamination of the core glass layer in the laminating step P3 is performed as below. First, the glass tube 15G on which the clad glass layer is laminated is rotated as in the first embodiment and the burner 58 is moved from the supply side of the raw material gas to the discharge side. Then, as in the first embodiment, a carrier gas, a SiCl₄ gas, and a GeCl₄ gas are supplied. Here, in the first embodiment, the raw material gas is changed as soot, and the soot is changed as the glass layer. However, in the manufacturing method, the raw material gas is changed as soot, but at this time point the soot is not changed as the glass layer. This point is different from the lamination of the core glass layer of the first embodiment. Then, in the manufacturing method, a solution containing an active element is impregnated into a gap of the deposited soot, and then is dried. In this way, the active element is held in the gap of the soot. Then, the glass tube is heated again so as to obtain the core glass layer in which the active element and the soot are integrated with each other. Furthermore, in the manufacturing method, even when heating the glass tube in order to deposit the soot becoming the core glass layer, the through-hole of the glass tube may be pressurized so that the outer diameter of the glass tube increases as in the lamination of the core glass layer of the first embodiment.

Subsequently, the collapse step P4 is performed, and the drawing step P5 is performed as in the first manufacturing method, thereby obtaining the optical fiber 20 of FIG. 7.

As described above, the invention has been described by exemplifying the first and second embodiments, but the invention is not limited thereto.

For example, the optical fiber of the first embodiment is not limited to a single-mode fiber, and may be a multi-mode fiber.

Further, in the laminating step of the first and second embodiments, only the core glass layer may be laminated without laminating the clad glass layer. In this case, the clad glass body 12P may be formed only by using the glass tube 15G to be prepared.

Further, in the above-described embodiment, the burner 58 is used as a heat source, but a heating heater which moves as the burner 58 does and surrounds the outer periphery of the glass tube 15G may be used. The method of manufacturing the optical fiber base material using such a heating heater may be considered as a kind of the MCVD method called an FCVD (Furnace Chemical Vapor Deposition) method.

Further, in the etching step P2 of the above-described embodiment, the pressurization is performed so that the outer diameter of the glass tube 15G becomes constant, and in at least a part of the laminating step P3, the pressurization may be performed so that the outer diameter of the glass tube 15G increases. In contrast, in at least a part of the etching step P2 of the above-described embodiment, the pressurization is performed so that the outer diameter of the glass tube 15G increases and in the laminating step P3, the pressurization may be performed so that the outer diameter of the glass tube 15G becomes constant.

### EXAMPLES

Hereinafter, the contents of the invention are more specifically described by referring to Examples and Comparative Examples, but the invention is not limited thereto.

### Comparative Example 1

A glass tube having an outer diameter of 40 mm, a thickness of 2.2 mm, and a length of 200 cm was prepared. The glass tube was set on a base material manufacturing device, and the lamination of a core glass layer was performed according to the MCVD method. In the MCVD method, the number of rotations of the glass tube was set to 20 rpm, an oxyhydrogen burner was moved at 50 mm/min from the supply side of the raw material gas to the discharge side thereof, and the traverse was performed 80 times. At this time, the temperature of the glass tube at a place with an oxyhydrogen flame was about 2000° C. Further, in the further traverse, the through-hole of the glass tube was pressurized so that the outer diameter of the glass tube becomes constant. The maximum whirling amount of the glass tube was 0.64 mm.

### Example 1

The core glass layer was laminated by the MCVD method as in Comparative Example 1 except that the outer diameter of the glass tube increased by 0.040% in the one-time traverse by the pressurization of the through-hole of the glass tube. The whirling amount of the glass tube at this time was about 0.1 when the whirling amount of the glass tube of Comparative Example 1 was set to 1.

### Example 2

The core glass layer was laminated by the MCVD method as in Comparative Example 1 except that the outer diameter of the glass tube increased by 0.050% on average in the one-time traverse by the pressurization of the through-hole of the glass tube. The whirling amount of the glass tube at this time was about 0.2 when the whirling amount of the glass tube of Comparative Example 1 was set to 1.

### Example 3

The core glass layer was laminated by the MCVD method as in Comparative Example 1 except that the outer diameter of the glass tube increased by 0.090% on average in the one-time traverse by the pressurization of the through-hole of the glass tube. The whirling amount of the glass tube at this time was about 0.2 when the whirling amount of the glass tube of Comparative Example 1 was set to 1.

### Example 4

The core glass layer was laminated by the MCVD method as in Comparative Example 1 except that the outer diameter of the glass tube increased by 0.140% on average in the one-time traverse by the pressurization of the through-hole of the glass tube. The whirling amount of the glass tube at this time was about 0.15 when the whirling amount of the glass tube of Comparative Example 1 was set to 1.

### Comparative Example 2

The core glass layer was laminated as in Comparative Example 1 except that a glass tube having an outer diameter of 38 mm and a thickness of 2.7 mm was used. The maximum whirling amount of the glass tube at this time was 0.51 mm.

### Example 5

The core glass layer was laminated by the MCVD method as in Comparative Example 2 except that the outer diameter of the glass tube increased by 0.070% on average in the one-time traverse by the pressurization of the through-hole of the glass tube. The whirling amount of the glass tube at this time was about 0.15 when the whirling amount of the glass tube of Comparative Example 2 was set to 1.

### Example 6

The core glass layer was laminated by the MCVD method as in Comparative Example 2 except that the outer diameter of the glass tube increased by 0.160% on average in the one-time traverse by the pressurization of the through-hole of the glass tube. The whirling amount of the glass tube at this time was about 0.21 when the whirling amount of the glass tube of Comparative Example 2 was set to 1.

The above-described result is illustrated in FIG. 8. FIG. 8 is a diagram illustrating a relation between an average expansion amount per each traverse and a whirling amount of a glass tube. As illustrated in FIG. 8, it is found that the whirling is remarkably suppressed by pressurizing the through-hole of the glass tube so that the outer diameter of the glass tube slightly increases when laminating the glass layer in the MCVD method.

Accordingly, according to the invention, since the soot derived from the raw material gas is deposited by a constant thickness in the circumferential direction, the thickness of the glass layer may become constant in the circumferential direction, and hence the eccentricity of the optical fiber base material manufactured by the invention is suppressed. Accordingly, such an optical fiber base material may manufacture a highly reliable optical fiber, and an optical fiber which is manufactured by using the optical fiber base material has high reliability.

As described above, according to the invention, a method of manufacturing an optical fiber base material that may manufacture a highly reliable optical fiber and a method of manufacturing an optical fiber using the same are provided.

What is claimed is:

1. A method of manufacturing an optical fiber base material using a MCVD method, comprising:
a step of heating a glass tube while rotating the glass tube, and supplying a gas into a through-hole of the glass tube,
wherein in at least a part of the step, the inside of the through-hole is pressurized so that an outer diameter of the glass tube increases.

2. The method of manufacturing the optical fiber base material according to claim 1, wherein
the step is a laminating step of laminating a glass layer on an inner wall of the glass tube, and
the gas is a raw material gas for laminating the glass layer.

3. The method of manufacturing the optical fiber base material according to claim 2, wherein
a heat source heating the glass tube heats the glass tube while moving along the longitudinal direction of the glass tube, and
the inside of the through-hole is pressurized so that the outer diameter of the glass tube increases by 0.040% to 0.160% while the heat source traverses once from a supply side of the raw material gas to a discharge side thereof.

4. The method of manufacturing the optical fiber base material according to claim 2, wherein the inside of the through-hole is pressurized so that the outer diameter of the glass tube is constant from the middle of the laminating step.

5. The method of manufacturing the optical fiber base material according to claim 3, wherein the inside of the through-hole is pressurized so that the outer diameter of the glass tube is constant from the middle of the laminating step.

6. The method of manufacturing the optical fiber base material according to claim 2, wherein the inside of the through-hole is not pressurized from the middle of the laminating step.

7. The method of manufacturing the optical fiber base material according to claim 3, wherein the inside of the through-hole is not pressurized from the middle of the laminating step.

8. The method of manufacturing the optical fiber base material according to claim 2, wherein the inside of the through-hole is pressurized so that the outer diameter of the glass tube increases during the laminating step.

9. The method of manufacturing the optical fiber base material according to claim 3, wherein the inside of the through-hole is pressurized so that the outer diameter of the glass tube increases during the laminating step.

10. The method of manufacturing the optical fiber base material according to claim 1, wherein
the step is an etching step of etching an inner wall of the glass tube, and
gas is an etching gas.

11. The method of manufacturing the optical fiber base material according to claim 1, wherein the pressurization is performed by supplying a pressurization gas to the gas discharge side of the glass tube.

12. The method of manufacturing the optical fiber base material according to claim 2, wherein the pressurization is performed by supplying a pressurization gas to the gas discharge side of the glass tube.

13. The method of manufacturing the optical fiber base material according to claim 3, wherein the pressurization is performed by supplying a pressurization gas to the gas discharge side of the glass tube.

14. The method of manufacturing the optical fiber base material according to claim 4, wherein the pressurization is performed by supplying a pressurization gas to the gas discharge side of the glass tube.

15. The method of manufacturing the optical fiber base material according to claim 5, wherein the pressurization is performed by supplying a pressurization gas to the gas discharge side of the glass tube.

16. The method of manufacturing the optical fiber base material according to claim 6, wherein the pressurization is performed by supplying a pressurization gas to the gas discharge side of the glass tube.

17. The method of manufacturing the optical fiber base material according to claim 7, wherein the pressurization is performed by supplying a pressurization gas to the gas discharge side of the glass tube.

18. A method of manufacturing an optical fiber, comprising:
an optical fiber base material manufacturing step of manufacturing an optical fiber base material using an MCVD method; and
a drawing step of drawing the optical fiber base material,
wherein in the manufacturing of the optical fiber base material, a glass tube is heated while rotating and a gas is supplied into a through-hole of the glass tube, where in at least a part of the heating and the supplying, the inside of the through-hole is pressurized so that the outer diameter of the glass tube increases.
